(19) United States
(12) Patent Application Publication
(10) Pub. No.: US 2009/0089947 A1
(43) Pub. Date: Apr. 9, 2009

(54) Cleaning device, cleaning tool and method of using the cleaning device

(76) Inventors: Ulf Eriksson, Enskede (SE); Par-Ake Jansson, Umea (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/314,354

(22) Filed: Dec. 9, 2008

Related U.S. Application Data
(62) Division of application No. 10/962,534, filed on Oct. 13, 2004.
(60) Provisional application No. 60/511,700, filed on Oct. 17, 2003.

(30) Foreign Application Priority Data
Apr. 2, 2003 (SE) 0300977.6
Apr. 10, 2003 (FI) 20030546

(51) Int. Cl. B08B 9/00

(52) U.S. Cl. 15/104.03

(57) ABSTRACT

The present invention relates to a cleaning device for cleaning outlet ports (11) or the like and/or outlet spouts (12) or the like in soda recovery boilers (13) or the like, the cleaning device comprising at least one connecting rod (9). The cleaning device has at least one front tool part (1a-d, 3, 6), mounted on said connecting rod (9).

The present invention also relates to a cleaning tool for use in the cleaning device as well as a method of using the cleaning device.

The present invention relates to a cleaning device for cleaning outlet ports or the like and/or outlet spouts or the like in soda recovery boilers or the like. The invention also relates to a cleaning tool for use in the cleaning device as well as two methods of using the cleaning device.

### PRIOR ART

Liquid soda that is tapped from a soda recovery boiler usually passes at least one outlet port and an outlet spout located under the same. The soda running out of the boiler has a temperature of approx. 1000° C. and, upon contact with air, a part of the soda solidifies and forms a solid “covering” in the port and the spout. Solidified soda blocks the flow and it occurs that lumps are to pass in the spout as well as that liquid soda splashes out in the boiler room. The usual way today to prevent that solidified soda blocks the flow is to clean outlet ports and outlet spouts manually at regular intervals by means of long levers. This work is heavy and risky.

### SUMMARY OF THE INVENTION

A first object of the present invention is to provide a cleaning device that is efficient in cleaning. A second object of the present invention is to provide a cleaning device that is useful for automatic cleaning. A third object of the present invention is to provide a cleaning tool for use in the cleaning device. A fourth object of the present invention is to provide methods to use the cleaning device that give the intended cleaning effect and simultaneously require minimal manual effort.

Thus, the invention comprises a cleaning device for cleaning outlet ports or the like and/or outlet spouts or the like in soda recovery boilers or the like, the cleaning device comprising at least one connecting rod. At least one front tool part is found, mounted on said connecting rod.

The cleaning device may comprise at least one rear tool part, mounted on said front tool part.

Said front tool part may in turn comprise at least one first cleaning part and at least one first holder part with bracket, said first cleaning part having a shape and size that closely connects to the corresponding shape and size of an outlet port or the like that is to be cleaned, so that said first cleaning part, if required, can be inserted into the outlet port and clean the same from solidified soda, cinder or the like.

Said first cleaning part may be in the shape of a hollow cylinder open in the ends, which cylinder has an essentially circular or oval cross-section. At least one slot may be present in the envelope surface of said cylinder. Said slot may run in the longitudinal direction of the cylinder, from one end to the other of the cylinder and through the entire length thereof, whereby said first cleaning part gets radially resilient properties.

Said rear tool part may in turn comprise at least one second cleaning part and at least one second holder part with bracket, said second cleaning part having a shape and size that closely connects to the corresponding shape and size of the interior of an outlet spout or the like that is to be cleaned, so that said second cleaning part, if required, can be inserted into the outlet spout and clean the same from solidified soda, cinder or the like. Said second cleaning part may comprise at least one flange-like scraping device, which upon cleaning scrapes in the outlet spout.

Said second holder part may be articulately connected to said first holder part. Said first holder part may be connected to the front part of said connecting rod. Said connecting rod may be connected to a drive mechanism enabling automatic operation of the cleaning device in a way decided beforehand.

Thus, the invention also comprises a cleaning tool for use in the cleaning device according to the above. The cleaning tool comprises at least one front tool part for mounting on a connecting rod.

The cleaning tool may comprise at least one rear tool part, mounted on said front tool part.

Said front tool part may in turn comprise at least one first cleaning part and at least one first holder part with bracket, said first cleaning part having a shape and size that closely connects to the corresponding shape and size of an outlet port or the like that is to be cleaned, so that said first cleaning part, if required, can be inserted into the outlet port and clean the same from solidified soda, cinder or the like. Said rear tool part may in turn comprise at least one second cleaning part and at least one second holder part with bracket, said second cleaning part having a shape and size that closely connects to the corresponding shape and size of the interior of an outlet spout or the like that is to be cleaned, so that said second cleaning part, if required, can be inserted into the outlet spout and clean the same from solidified soda, cinder or the like.

Thus, the invention also comprises a method of using the cleaning device according to the above for cleaning outlet ports or the like in soda recovery boilers or the like. The method comprises the steps of

(A) directing the cleaning device against an outlet port or the like that is to be cleaned and in that connection locating a front end of a first cleaning part essentially right opposite said outlet port,

(B) inserting said first cleaning part into said outlet port sufficiently far in order to clean the port from occurring solidified soda, cinder or the like, and

(C) bringing back said first cleaning part entirely from said outlet port.

Thus, the invention also comprises a method of using the cleaning device according to the above for cleaning outlet spouts or the like in soda recovery boilers or the like. The method comprises the step of

(D) bringing the cleaning device along an outlet spout or the like that is to be cleaned and in such a way that a first cleaning part and/or a second cleaning part will run in the outlet spout essentially through the entire length thereof and hence clean the spout from occurring solidified soda, cinder or the like.

The cleaning device can be brought along said outlet spout in such a way that said second cleaning part also will run past the lower end of the outlet spout, said second cleaning part also cleaning around said lower end and under the spout in an area closest to said lower end, possible beard-like formations in the form of solidified soda, cinder or the like being removed. The cleaning device can be operated automatically by means of a drive mechanism.

### LIST OF DRAWINGS

FIG. 1 shows, in a perspective view, a cleaning tool according to the invention included in a cleaning device according to the invention.

FIG. 2 shows, in a side view, the tool according to FIG. 1.

FIG. 3a shows, in a view from above, the tool according to FIG. 1.

FIG. 3b shows, in a view from below, the tool according to FIG. 1.

FIG. 4 shows, in a section along the line A-A in FIG. 2, a front part of the tool according to FIG. 1.

FIG. 5 shows, in a section along the line B-B in FIG. 2, a rear part of the tool according to FIG. 1.

FIG. 6 shows, in a side view from a first side, a connecting rod and a drive mechanism intended for use with the tool in FIG. 1 and included in a cleaning device according to the invention.

FIG. 7 shows, in a side view from a second side, the connecting rod and the drive mechanism according to FIG. 6.

FIG. 8a shows, in a side view, a starting position in cleaning by means of the tool according to FIG. 1.

FIG. 8b shows, in a side view, a first operation position in cleaning by means of the tool according to FIG. 1.

FIG. 8c shows, in a side view, a second operation position in cleaning by means of the tool according to FIG. 1.

### DESCRIPTION OF EMBODIMENTS

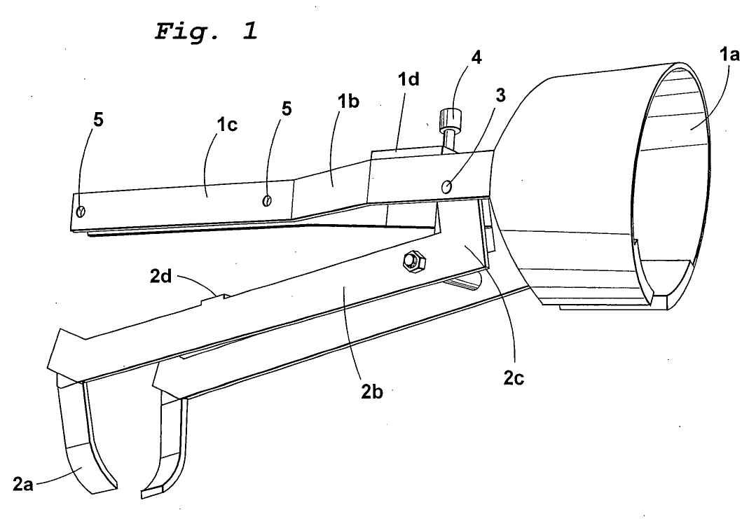

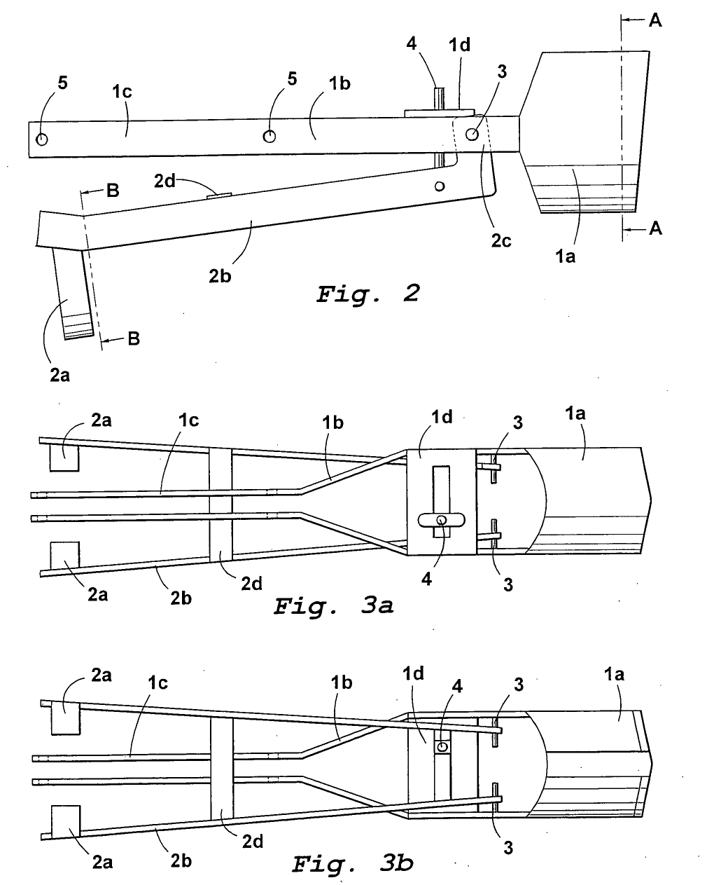

From FIGS. 1-3 is evident how two parts of a cleaning tool according to the invention included in a cleaning device according to the invention appear and are assembled, viz. a front tool part 1a-d, 3, 6 and a rear tool part 2a-d. The front tool part 1a-d, 3, 6 comprises a first cleaning part 1a, a first holder part 1b with bracket 1c and a first strut 1d. The rear tool part 2 comprises a second cleaning part 2a, a second holder part 2b with bracket 2c and a second strut 2d. The front tool part 1a-d, 3, 6 and the rear tool part 2a-d are articulatedly interconnected with each other around the axle journals 3 that are fixedly connected to the first cleaning part 1a via the first holder part 1b. An adjustment device 4 enables adjustment of the desired angle between the first and second holder parts 1b and 2b. In the first holder part 1b, there are, in the bracket 1c, holes 5 for bolts or the like for mounting the first holder part 1b on a connecting rod or the like.

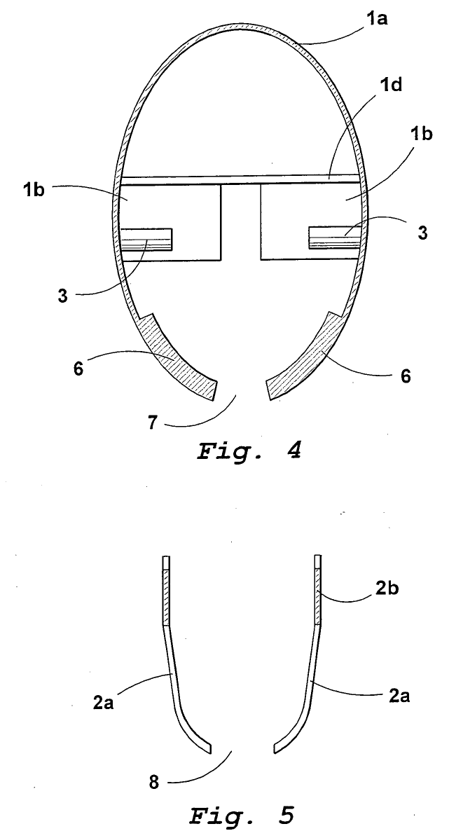

From FIG. 4 is evident that the first cleaning part 1a is in the form of a hollow cylinder open in the ends, which cylinder has an oval cross-section, the section being seen from the front. The shape of the cross-section is adapted to the shape of the outlet port 11 that is to be cleaned and the length of the cylinder is adapted to the depth of the same outlet port 11, i.e., usually the wall thickness of the boiler. Two reinforcements 6 are found on the inside of the cylinder, one on each side of a slot 7 in the otherwise continuous cross-section shape. Furthermore, from the figure the first strut 1d, the first holder part 1b and the axle journals 3 are evident, which all are included in the front tool part 1a-d, 3, 6.

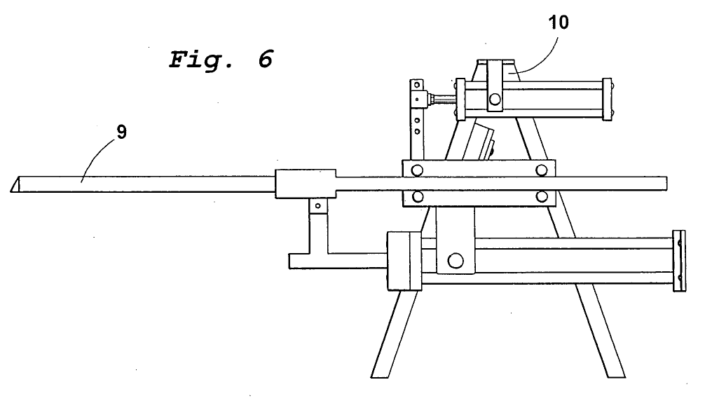

From FIG. 5 is evident how the second cleaning part 2a appears in profile immediately behind a section that is seen from the front. By the presence of a slot 8, the second cleaning part 2a is divided into two flange-like downward-directed scraping devices 2a. The length of the second holder part 2b is adapted to the length of the outlet spout 12 that is to be cleaned.

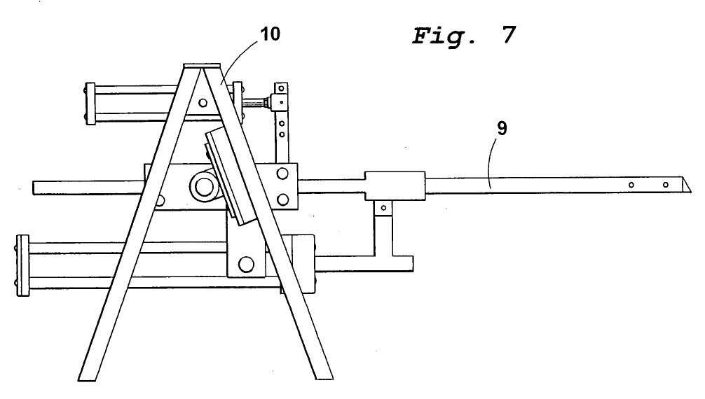

In the cleaning device according to the invention, the first holder part 1b is, via the bracket 1c thereof, in any known way—for instance by screw joint, bolt joint, rivet joint, welding and/or brazing—mounted on a connecting rod 9. From FIGS. 6 and 7 is evident how the connecting rod 9 in turn is connected to a drive mechanism 10, which enables automatic operation of the cleaning device in a way decided beforehand. The drive mechanism 10 is of a previously known type.

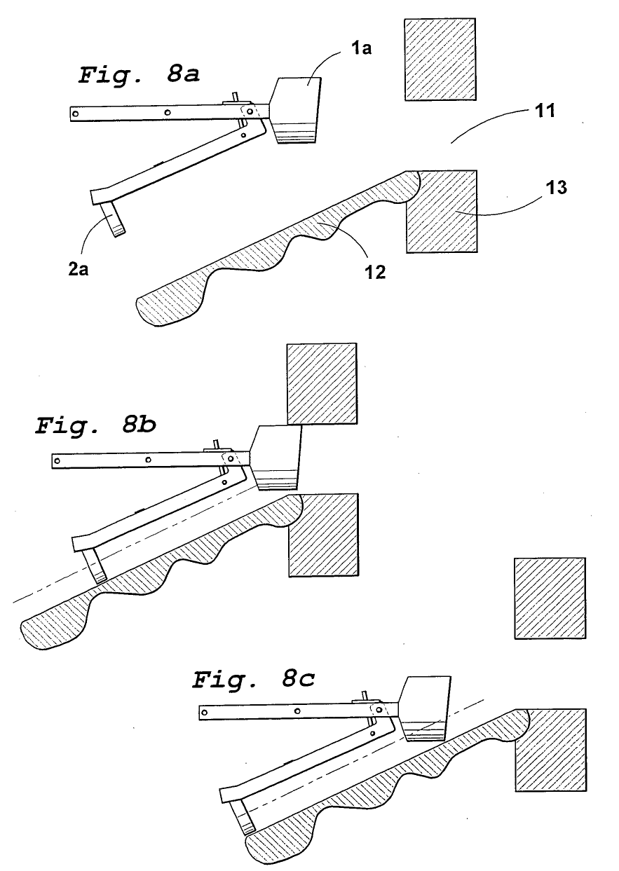

Here, a suitable method of using the cleaning device according to the invention in cleaning an outlet port 11 with the appurtenant subjacent outlet spout 12 in connection with a soda recovery boiler 13 will now be accounted for more closely, and in connection with the FIGS. 8a-c.

First, the drive mechanism 10 is brought to direct the cleaning device against an outlet port 11 that is to be cleaned and in that connection locate the front end of the first cleaning part 1a right opposite said outlet port 11, see FIG. 8a, wherein it should be observed that in the respective FIGS. 8a-c, for the sake of clarity, only the front tool part 1a-d, 3, 6 and the rear tool part 2a-d of the cleaning device have been drawn-in, which parts together constitute said cleaning tool.

Then, the drive mechanism 10 is brought to insert the first cleaning part 1a in said outlet port 11 sufficiently far in order to entirely clean the port 11 from occurring solidified soda, cinder or the like, see FIG. 8b, which shows the introduction of the course of events. The cleaning takes place mechanically by the exterior shape of the first cleaning part 1a closely connecting to the interior shape of the outlet port 11, and accordingly occurring solidified soda, cinder or the like being “peeled” off from the interior walls of the outlet port 11. By the presence of the slot 7, the exterior shape of the first cleaning part 1a is somewhat flexible, i.e., the exterior wall in the cleaning part 1a may spring somewhat in the radial direction. In this way, the first cleaning part 1a may compensate for certain variations in the shape of the outlet port 11 and it is avoided that the first cleaning part 1a is caught in the outlet port 11 in the event that cinder and solidified soda have formed thicker layers than normally in the outlet port 11. The slot 7 also contributes to decreasing the risk of soda being caught on the first cleaning part 1a and comes with it back after accomplished cleaning of the outlet port 12.

Then, the drive mechanism 10 is brought to bring back said first cleaning part 1a entirely from said outlet port 11 and subsequently the drive mechanism 10 is brought to bring the cleaning device along the appurtenant outlet spout 12 that is to be cleaned and in such a way that the first cleaning part 1a and the second cleaning part 2a will run in the outlet spout 12 through the entire length thereof from above and down and hence clean the spout 12 from occurring solidified soda, cinder or the like, see FIG. 8c. This takes place in such a way that the first cleaning part 1a cleans an upper part of the spout 12 and the second cleaning part 2a simultaneously cleans a lower part of the spout 12, wherein an overlapping can take place so that an intermediate part of the spout 12 is cleaned by the first cleaning part 1a as well as the second cleaning part 2a. The second cleaning part 2a will also run past the lower end of the outlet spout 12 at the end of the spout, the second cleaning part 2a also cleaning around the lower end of the spout 12 and under the spout 12 in an area closest the lower end thereof, possible beard-like formations in the form of solidified soda, cinder or the like being removed also there.

The drive mechanism 10 comprises a control system that may be maneuvered automatically via a timer or manually from a maneuvering room. The control system may comprise one or several computers.

Said front tool part 1a-d, 3, 6 and rear tool part 2a-d are manufactured from stainless acid-proof steel or another suitable material that resists corrosive environment and high temperature.

In the cleaning device according to the invention, the first holder part 1b does not need, via the bracket 1c thereof, to be fixedly mounted on the connecting rod 9 but may be movably, for instance articulatedly, mounted. In that connection, some kind of known locking device may be present in order to, for a shorter or longer time, fix the holder part 1b with the bracket 1c in a desired position in relation to the connecting rod 9. The first holder part 1b with the bracket 1c may alternatively be made integrally with the connecting rod 9.

Instead of being mounted on the front tool part 1a-d, 3, 6, the rear tool part 2a-d may be mounted directly on the connecting rod 9 and anywhere along the length thereof. The rear tool part 2a-d may alternatively be mounted on the front tool part 1a-d, 3, 6 as well as directly on the connecting rod 9. The rear tool part 2a-d may alternatively be made integrally with the front tool part 1a-d, 3, 6 and/or the connecting rod 9.

The cleaning device according to the invention may also be used by hand, i.e., without help from the drive mechanism 10, the connecting rod 9 having the front tool part 1a-d, 3, 6 and/or the rear tool part 2a-d hence being handled entirely manually and as an alternative to a simple manual lever.

The invention is not limited to the embodiments shown here but may be varied within the scope of the appended claims.

1-15. (canceled)

16. A method of using a cleaning device that includes a connecting rod and a front tool part mounted on the connecting rod to clean outlet ports of boilers, comprising by the steps of:
(a) directing the cleaning device against an outlet port that is to be cleaned and locating a front end of a first cleaning part essentially right opposite said outlet port,
(b) inserting said front cleaning part into said outlet port sufficiently far in order to clean the port, and
(c) withdrawing said first cleaning part entirely from said outlet port.

17. A method of using a cleaning device that includes a connecting rod and a front tool part mounted on the connecting rod to clean outlet spouts of boilers, comprising by the step of:
(d) bringing the cleaning device along an outlet spout that is to be cleaned and in such a way that a first cleaning part and/or a second cleaning part will run in the outlet spout essentially through the entire length thereof and hence clean the spout.

18. The method according to claim 17, wherein the cleaning device is brought along said outlet spout such a way that said second cleaning part also will run past a lower end of the outlet spout, said second cleaning part also cleaning around said lower end and under the spout in an area closest to said lower end.

19. The method according to claim 17, comprising automatically moving the cleaning device using a drive mechanism.
